(19) United States
(12) Patent Application Publication
(10) Pub. No.: US 2009/0321365 A1
(43) Pub. Date: Dec. 31, 2009

(54) SYSTEM OF WATER TREATMENT

(76) Inventors: Emil Eriksson, Stockholm (SE); Niclas Dahl, Tumba (SE); Per Borin, Nacka (SE); Johan Markstedt, Farsta (SE); Peter Svensson, Kalmar (SE); Carl Tullstedt, Saltsjo-Boo (SE)

Correspondence Address: MICHAUD-DUFFY GROUP LLP, 306 INDUSTRIAL PARK ROAD, SUITE 206, MIDDLETOWN, CT, 06457, US

(21) Appl. No.: 12/442,986

(22) PCT Filed: Sep. 26, 2007
(86) PCT No.: PCT/SE2007/050677

§ 371 Date: Jun. 16, 2009

(30) Foreign Application Priority Data
Sep. 26, 2006 (SE) 0602007-7
Dec. 6, 2006 (SE) 0602619-9
Dec. 6, 2006 (SE) 0602620-7

(51) Int. Cl. C02F 1/32; C02F 1/00

(52) U.S. Cl. 210/741; 210/748.1; 210/744; 210/742; 210/747; 210/137; 210/108

(57) ABSTRACT

The present invention relates to a system for treating contaminated ballast water, comprising water inlets and outlets, piping connected to said inlets and outlets, at least one treatment unit connected to said piping, which treatment unit comprises UV radiation means, and catalysts, capable of, during operation, create photo-catalytic reactions in ballast water flowing through said unit, filter means for said ballast water and valve means for controlling the flow through said piping, treatment unit and filter means, characterised in control unit capable of, controlling and monitoring of said system for ensuring that no untreated water leaves the system in an uncontrolled manner.

### TECHNICAL AREA

The present invention relates to a method and system for treating water, and in particular treating ballast water is ships.

### TECHNICAL BACKGROUND

There is a greater and greater demand on the environmental effects of polluted liquids and in particular water. The access to clean and unpolluted water has become a major issue in the world. This entails both fresh water as well as salt water. The fresh water supply in many areas of the world is limited at the same time as many of the fresh water sources are polluted by man.

Regarding salt water, for many decades all sorts of harmful and polluting substances have been dumped in the seas, such as chemicals, crude oil, petrol, heavy metal and soot from factory chimneys, which pollutants affect the delicate biological balance in the seas.

The biological balance in the seas has also been affected by man due to ballast water handling. Ships are arranged with ballast water tanks that are filled in order to stabilize them when the ships are not fully loaded with cargo. That is, when a ship has offloaded its cargo at a port in for instance the black sea, and then receives instructions to pick up another cargo in a port in the red sea, it fills its ballast water tanks with sea water from the black sea. When the ship then reaches the port in the red sea, it empties the ballast water tanks for receiving new cargo. Thus the species that were in the water of the black sea have been transported to the red sea. The transported species may be completely different from the normal species of the red sea and may thus cause large ecological problems. It is well known that species that are transported from their normal environment to a new environment can cause great problems, for example due to that they have no normal enemies in the new environment, that the local species obtain diseases and are wiped out from the transported species, etc. Some species that have been recognized as major ecological problem if spread are cholera, kelp, toxic algae and mussels, just to mention a few. It is estimated that about 3-5 billion tonnes of ballast water are transported around the world. It is thus not surprising that this has become a major issue where the International Maritime Organisation of UN has issued a convention that with start from 2009 will put demand on all commercial ships to be equipped with and use special systems for handling ballast water.

Many systems have been developed for treating and purifying water such as with chemicals where chloride is commonly used. In order to reduce the negative impact that many chemicals have on the environment, systems have been developed that do not use chemicals but rely on other effects in order to kill organisms in water in order to purify it.

Methods have been developed in several countries for purifying water with ozone (O3) in drinking water installations and bathing facilities, and also ozone dissolved in water for cleaning, disinfection and sterilization of articles. The reaction capacity of ozone (2.07 V electrochemical oxidation potential) is ascribed to the fact that it is a powerful oxidant. The high chemical reactivity is coupled with the unstable electron configuration which seeks electrons from other molecules, which thus means that free radicals are formed. In this process, the ozone molecule is broken down. By means of its oxidizing effect, the ozone acts rapidly on certain inorganic and organic substances.

Its oxidizing effect on certain hydrocarbons, saccharides, pesticides, etc., can mean that ozone is a good choice of chemical in certain processes. A combination of ozone, oxygen, hydroperoxide and UV radiation means that the reaction proceeds much more quickly and more efficiently by virtue of the generation of more free radicals. The photolytic and photo-catalytic process is used to decompose the organisms, rendering them harmless, and for that purpose light with different wave lengths are used. One of the common spectras used is UV-light where certain wave lengths are more effective than others in creating the desired effect. For example, wavelengths below 200 nm have a good effect in creating ozone from the oxygen in the liquid, which ozone reacts with the organisms. In order to increase the effect some methods use additional oxygen to promote the creation of ozone.

Another method is to radiate the created ozone with UV light of a certain wave length in order to break down the ozone and create radicals, which are more aggressive than ozone. Such a method is disclosed in EP 0 800 407, in which the medium which is to be treated is introduced into some form of enclosure. In the enclosure, the medium is exposed to UV radiation with a spectral distribution within the range of 130-400 m.

The wavelengths below 200 nm, in particular, convert the oxygen in the medium to ozone molecules (O3). The ozone molecules formed are at the same time decomposed by radiation within the above-mentioned wavelength range, especially at wavelengths of—400 nm. At the same time, the O2 formed is broken down to form atomic oxygen.

In order to increase the efficiency during generation of free radicals, in particular HO′ radicals, catalysts are utilized, arranged in the zone where the ozone is decomposed to free radicals. Materials used for the catalysts could comprise metal and/or metal oxides, such as noble metals, aluminium oxide, titanium oxide, silicon oxide and mixtures thereof.

For treating ballast water in ships, it is very important that the ballasting and deballasting in connection with the treatment is performed such that it is ensured that no untreated water can leave the ship, that the equipment, the ballast water pumping equipment as well as the treatment equipment is controlled and monitored so that a safe and optimal function is obtained as well as being able to indicate malfunction of different parts of the system so that appropriate measures can be taken and also that the safety of the ship is not endangered.

The production of radicals can be made in reactors or purifiers having a number of UV radiation means that are capable of generating ozone and at the same time break down the ozone in order to generate radicals in the presence of catalysts. The generating means are preferably UV lamps emitting certain wavelengths, which lamps are operated by drive units. The power of these lamps are rather high and requires quite a lot of power from the drive units, which in turn means that they generate a lot of heat. The drive units are placed in cabinets for protection, and preferably in gas-tight cabinets to meet up to the requirements regarding safety against explosion, so called EX-classification. The heat thus generated in the cabinets has to be taken care of in order that the components inside the cabinet do not overheat. Because of the gas-tight cabinets, it is not possible to have air inlets and outlets to circulate cooling air in the cabinet.

Some solutions of cooling of heat generating equipment inside enclosures have been developed. One example is disclosed in EP 0 361 196 where a cooling system made of copper for corrosion resistance is arranged inside a cabinet. The drawback with that solution is that the cabinet is not gas-tight and further that the cooling device is arranged inside the cabinet. This in turn means that the cabinet has to be arranged with passages for the piping and further that the equipment inside the cabinet may be damaged if there is a leakage in the cooling system. FR 2624684 discloses a similar solution of cooling the interior of an enclosure, where the cooling piping is arranged inside the enclosure. U.S. Pat. No. 7,051,802 discloses a cooling apparatus where air is cooled by an external cooling source of cooling liquid and then blown through the enclosure. The cabinet disclosed is thus arranged with air inlet and outlet and may not be used in environments where the equipment inside the cabinet must be separated from the environment, such as in EX-environments.

There is thus a need for a cooling device that ensures adequate cooling of heat generating components inside a gas-tight cabinet without the risk of damaging the components and/or affecting the environment, such as in explosive environments.

Filters are used in many areas and applications for filtering out solids in fluids. One application is systems for treating ballast water in ships. The primary aim with these systems is to prevent organisms living in one water area of the world to be transported to other water areas, which are not their natural habitat, and which organisms may adversely affect the natural sea life, if placed in new environments.

These systems comprise some type of treatment means that kill off the organisms in the ballast water. However, the sea water to be treated may contain larger organisms and other matter that is not desirable to have entering the ballast water treatment system. Therefore they are arranged with filters on the inlet piping of the ballast water system. The filters may contain fine meshed filter plates or cylinders effectively filtering out matter that is larger than the size of the mesh.

However in order to have a proper function of the filter, they have to be cleaned periodically. One method of cleaning filter elements or candles is back-flushing the filter components in order to remove larger matter that has been filtered out. The back-flushing liquid must not be discharged with untreated organisms present, and regarding ballast water the filter can only be used during ballasting because during the cleaning process of back-flushing the reject water either has to be pumped back on the same place as the ballasting was done, or be treated.

Usually the reject water is pumped through the back-flush piping system of the ship, which means that when the ballast water operation is completed there will still be contaminated water present in the back-flush piping between the filter and the discharge place. This water will then be pushed into the sea during the next ballasting when the ship is in a new place and therefore contaminated water will be pumped overboard.

### BRIEF DESCRIPTION OF THE INVENTION

The aim of the present invention is to provide a system for treatment of ballast water in ships that will provide full function and control of the equipment and full safety of the ship as well as full control of the treatment process in order to minimize the risk of untreated water leaving the ship.

This aim is achieved by the content of the independent patent claims.

Preferable embodiments are subject of the dependent patent claims.

The system for treating contaminated ballast water according to the present invention, comprises water inlets and outlets, piping connected to said inlets and outlets, at least one treatment unit connected to said piping, capable of, during operation, treat ballast water flowing through said unit, filter means for said ballast water and valve means for controlling the flow through said piping, treatment unit and filter means. In order to have a very safe and efficient treatment of ballast water it comprises a control unit arranged and capable of managing and controlling all the different process sequences during start-up, ballasting, deballasting and cleaning as well as all failure functions and situations, for ensuring that no untreated water leaves the system in an uncontrolled manner.

According to one aspect of the invention, it may as one option rely on AOT technology for treating ballast water, utilizing UV radiation lamps together with catalysts. These lamps are very efficient in producing both ozone and free radicals in reactive zones where catalysts are present. They do however require a start-up time in order to function properly, and the system according to the present invention sees to that there is a cooling flow of non-contaminated water during the start-up. Also should the level of cooling water be too low and/or the temperature become too high during start-up, this is taken care of by the control unit.

Further the treatment of contaminated ballast water does only take place when the treatment unit is fully functioning. Should one of the lamps break down during operation, the control unit handles this situation and shuts down the treatment unit. Also if a treatment unit shuts down, an alarm is sent to the control panel of the ship to adjust the flow through the system accordingly. Preferably this is also logged so that there is a treatment history of the system.

Further the system comprises additional beneficial functions that the control unit controls and monitors, such as back-flushing of the filter, cleaning of the lamps of the treatment unit. Thus the control unit manages and controls all the different process sequences during startup, ballasting, deballasting and cleaning as well as all failure functions and situations that could occur when using the system. This is all done in a very reliable way, ensuring that no contaminated ballast water can leave the ship in an uncontrolled manner.

According to another aspect of the present invention, the aim with the present invention is ensure proper cooling of different components comprised in the system of the present invention.

In that respect it is characterised in a cooling device to be used with system for treating ballast water, having a substantially gas-tight cabinet containing heat generating components, which device comprises a heat conducting panel attachable to said cabinet, and when attached is arranged adjacent said heat generating components, piping arranged to said panel and connectable to cooling media, and attachment means for attaching said piping in contact with said panel.

According to a further aspect of the invention, said panel constitutes a wall part of said cabinet and is attached sealingly to said cabinet. Preferably said heat generating components are attached to said panel.

According to yet an aspect of the invention, the surface of the panel facing the interior of the cabinet is arranged with cooling fins and has preferably a thickness of at least 15 mm.

According to a further aspect of the invention, it further comprises an insulation arranged outside said piping.

Advantageously the piping is connectable to a low temperature water circuit of a ship.

There are a number of advantages with the present invention. Because the heat transferring panel and the cooling piping is arranged outside the cabinet with the heat generating components arranged adjacent, or even directly, to the panel, there is no risk for leakage of cooling media inside the cabinet at the same time as a good cooling effect is obtained in that the heat from the components are transferred to the panel and cooled by the cooling piping.

The panel could also be made as a wall part of the cabinet and attached sealingly to the other wall parts of the cabinet. The panel then becomes an integral part of the cabinet and it is possible to use its inner surface to directly attach heat generating components to that surface. In order to maintain the gas-tightness a seal is arranged between the panel and the cabinet. Preferably cooling fins are also arranged on the inner surface of the panel to increase the heat transfer properties.

Preferably the panel has a quite significant thickness which promotes the heat transfer but also gives stability to the cabinet and support to the components attached to the panel. In order to further increase the effectiveness of the cooling device, insulation is arranged outside the cooling piping for “directing” the cold towards the panel, which insulation could be a plate or panel of appropriate insulating material.

For ease of installation and operation and for ensuring a good cooling effect the device is preferably attached to a low temperature water circuit of a ship, whereby it is possible to obtain cooling water with controlled temperature.

According to a further aspect of the present invention, is to provide a method and system in a system for treating ballast water, where contaminated water from a back-flush cleaning operation is prevented from being discharged in unwanted places.

According to a main aspect of the invention it is characterised by a method of cleaning a filter arranged in a ballast water treatment pipe system arranged in a ship, which pipe system comprises a back-flush piping between said filter and a discharge outlet, which filter has been used for filtering objects in a contaminated fluid, comprising the steps of creating a back-flush flow through said filter and said back-flush piping, and then treating at least said back-flush piping with fluid in order to remove contaminants from the back-flush piping that have been removed from the filter during said back flow. Preferably also said filter is treated with fluid.

According to another aspect of the invention the back flow is performed several times in order ascertain the removal of contaminants from the back-flush piping.

According to an alternative, said fluid is fresh water, vapour gas or combinations of these.

Said fresh water could be taken from the tap water system of the ship or from an engine cooling system of the ship.

According to another aspect, said fresh water is heated before treatment.

According to a further major aspect, it comprises a system for performing the method. Preferably the system is provided with means for controlling the process via sensors and adjustable units automatically. If the system is capable of sensing the pressure drop over the filter, it may be able to initiate a self-cleaning treatment of the filter.

There are several advantages with the present invention. Because the present invention is capable of removing contaminants in the back-flush piping after the back-flush cleaning of the filter at the ballasting site, the risk of having contaminated water remaining in the system is greatly reduced, which contaminated water otherwise would have been discharged at another location, which thereby would render the ballast water treatment system ineffective.

According to the invention, the treatment and removal of contaminated water in the filter and the back-flush piping may be performed by different types of liquid. According to one aspect, sea water at the ballasting site is used a number of times for removing contaminants that had been filtered out by the filter. The contaminants that entered the system during ballasting are thus discharged back at the same site.

According to another aspect, fresh water from the ship is used for the treatment. This further elevates the security that no contaminants can remain in the system. In that respect both tap water and cooling water of the ship may be used. Preferably the water used is heated before treatment, which even further elevates the security and efficiency of the treatment. Also heated vapour could be used, providing the same effect as hot water. Further, gas could be utilized, such as for example ozone or radicals, which are potent in killing off any organisms and contaminants.

These and other aspects of and advantages with the present invention will become apparent from the following detailed description and from the accompanying drawings.

### BRIEF DESCRIPTION OF THE DRAWINGS

In the following detailed description of the invention, reference will be made to the accompanying drawings, of which

FIG. 1 is a schematic figure of a system for treating ballast water according to the present invention,

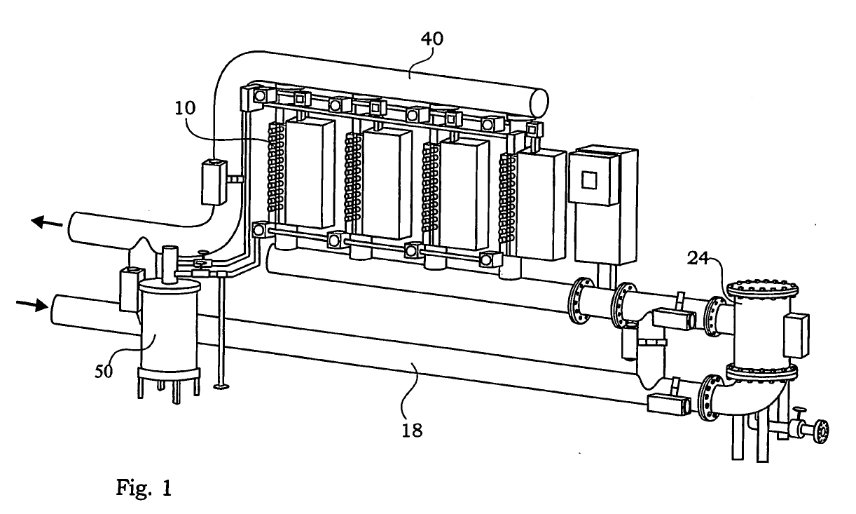

FIG. 2 is a detailed chart over a ballast water treatment system according FIG. 1,

FIG. 3 shows schematically a treatment unit comprised in the system according to the present invention

FIG. 4 shows one embodiment of a cooling device comprised in the present invention in an exploded perspective view,

FIG. 5 shows a detailed view of a fastening means comprised in the embodiment of FIG. 4,

FIGS. 6 and 7 show different ways of mounting the device of FIG. 4,

FIG. 8 shows another embodiment of a cooling device comprised in the present invention,

FIG. 9 shows a cross-sectional view of a filter that may be utilized with the present invention,

FIG. 10a, b shows a filtration and back-flush phase of the filter, and

FIG. 11 shows a schematic treatment unit.

### DETAILED DESCRIPTION OF THE INVENTION

The present invention makes use of non-chemical containing technology for water. Figure one shows schematically a system for treating ballast water including liquid treating unit or reactor 10. The rest of the overall system comprises an inlet pipe 18, a filter 24, outlet pipe 40 and a cleaning unit 50.

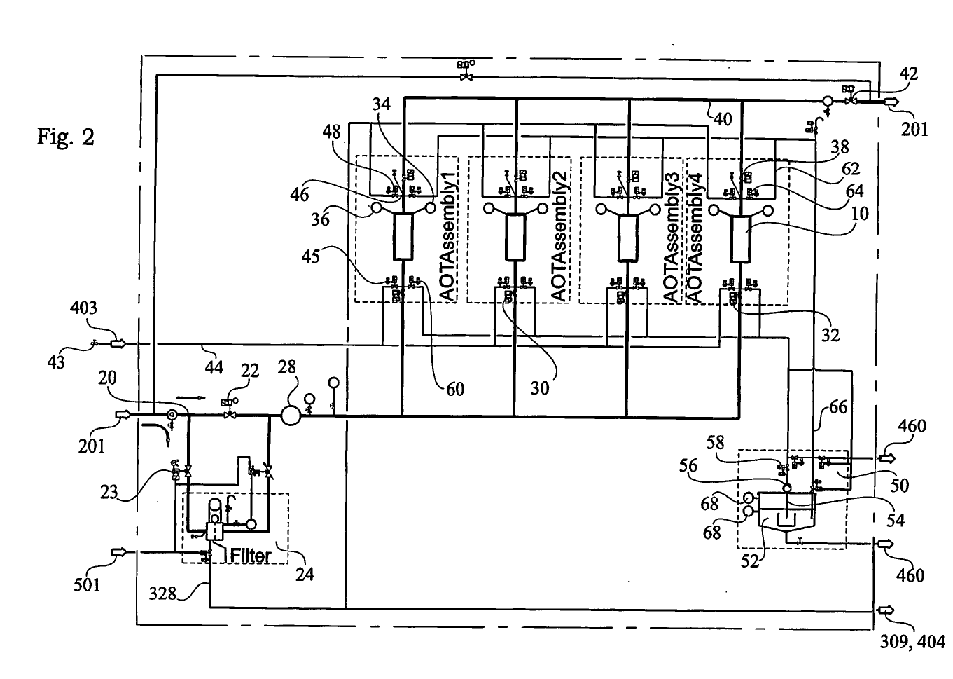

The ballast water treatment system and its function according to the present invention will be described in more detail in connection with FIG. 2. The water intake to the main pipe 18 of the system both for ballasting and deballasting is denoted with arrow 201. A ballast water pump (not shown) controlled by the control system of the ship is arranged to the inlet for pumping water through the system. Adjacent the inlet a pipe branch is arranged 20 having a closing valve 23, where the main pipe after the branch in the flow direction is arranged with a main closing valve 22. The other branch leads to a filter arrangement 24 and then back to the main pipe via a closing valve 26 downstream the main closing valve. Further downstream flow sensors 28 and pressure sensors 29 are arranged to the main pipe. In the embodiment of the system shown, the main pipe is then branched into four parallel pipe branches 30, each arranged with an inlet closing valve 32.

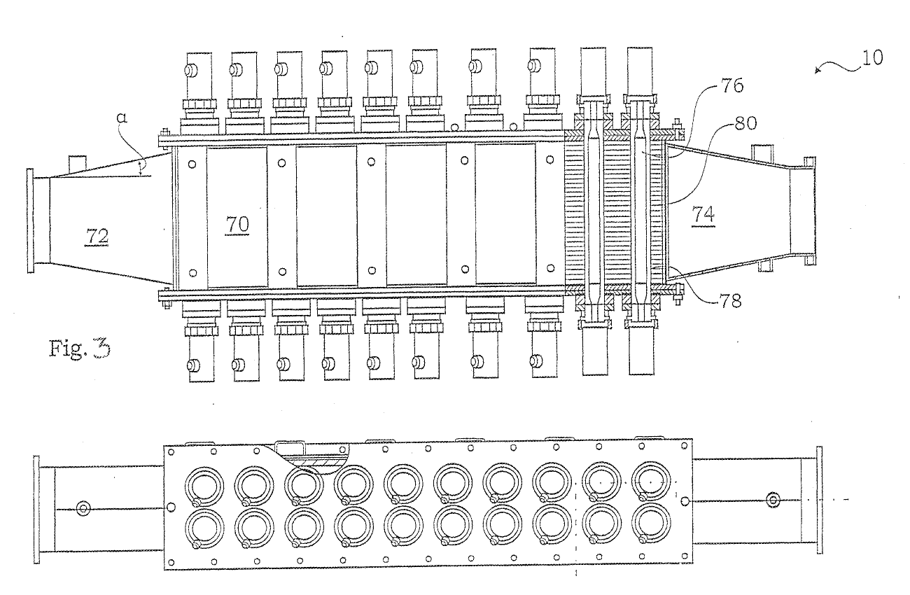

On each branch a liquid treating unit 10 or reactor is arranged. As a non-limiting example, the liquid treating unit could be utilizing AOT (advanced oxidation technology). The AOT reactor utilizes three important components for treating water flowing through the unit. One is UV-generating means, i.e. wavelengths within the ultraviolet spectra, <380 nm, of energies sufficient for photo catalysis and/or direct elimination of micro-organisms and/or direct formation of free radicals in the liquid or components dissolved therein and/or direct formation of ozone from oxygen present as gas or dissolved in the liquid. The wavelengths enable the second component which is generating of ozone in the water and at the same time breaking down the ozone to form free radicals. The third component is arranging catalysts in the reactive zone where ozone and free radicals are produced, in order to increase the amount of free radicals. According to the embodiment shown in FIG. 3, the AOT purifier comprises a housing 70, in the shown embodiment as a generally elongated enclosure with a rectangular cross-section and with in- and outlets 72, 74 at each end of the enclosure. When water is flowing in the enclosure it will flow in the direction of the elongated enclosure between the inlet and the outlet. In the enclosure a number of UV radiating light sources 76 are arranged in elongated tubes of quartz glass 78, which extend between the opposite walls of the compartment. The light sources are connected to suitable power supply. The UV radiating light source is chosen such that it emits wave lengths in the region of 130-400 nm for converting oxygen in the medium to ozone molecules (O3) and for decomposing the ozone molecules.

Further a number of plates 80 are arranged in the enclosure, the extension of which coincide with the direction of flow and thus perpendicular to the extension of the lamps. The plates are arranged in stacks with a certain distance between them. The plates act as catalysts for the AOT process thus boosting the amount of radicals produced. The plates are thus made of a material with catalytic properties to increase the number of radicals produced in the reactive zones. The material could include metal and/or metal oxides, such as noble metals, aluminium oxide, titanium oxide, silicon oxide and mixtures thereof.

In the interior of the reactors very thorough mixing and turbulence is provided in order to ensure that every volume of the liquid passing though the reactive zone is exposed to free radicals, providing a very complete treatment. The turbulence and mixing is obtained by many components in the reactor. The positioning and shape of the lamps is one component; the arrangement of the catalysts both in relation to the lamps and to the direction of flow as well as the shape, surface design also add to the thorough mixing, and in this aspect the prevention of dead zones close to the catalyst surfaces where the radicals are the most potent. It is thus important the transportation of light from the lamps to the active surfaces of the catalysts, the transport of organisms to the vicinity of the surfaces and the transportation of radicals from the surfaces to the liquid volume is optimized.

Each reactor is arranged with a temperature sensor 34 and a level sensor 36. After each reactor as seen in the flow direction, a closing valve 38 is arranged. The branches from the reactors are the reconnected to a main pipe 40, which is connected to an outlet 201, which outlet is provided with a position valve (not shown) for directing the flow either to the ballast tanks of the ship or out from the ship. The outlet pipe is also arranged with a closing valve 42. A start-up cooling flow system for the reactors is also arranged. It comprises an inlet 403 from the cooling system of the ship arranged with a closing valve 43. The pipe 44 then branches to all reactors and connect to their main inlet pipes after the closing valve 32 of these. After each reactor a return branch 46 is connected to the main outlet pipes, where each return branch is arranged with a closing valve 48. The return branches are connected to a main return pipe.

Further the system of the present invention is arranged with a cleaning unit 50 comprising a tank 52 filled with cleaning media in liquid form. An inlet pipe 54 from the tank is arranged with a pump 56 and a closing valve 58 downstream of the pump. The pipe is then branched into four branches where each branch is connected to a reactor downstream of its respective inlet closing valve 32. Each branch is also arranged with a closing valve 60. After each reactor in the direction of flow and before the closing valves, a branch 62 is arranged, which is also arranged with a closing valve 64, where each branch is connected to a return pipe 66 back to the cleaning unit. The tank of the cleaning unit is arranged with level sensors 68, capable of sensing the level of cleaning liquid. All sensors are connected via electrical lines to a control unit containing the appropriate means for handling signals from the sensor, perform necessary actions based of the type of signals, as will be described below. The control unit thus comprises processor means, memory means, I/O units and machine-human interface for communication. The control unit also comprises a communication means for communicating with other control systems of the ship, for example control panels arranged on the commando bridge or in the engine room. This is important since some of the ballasting/deballasting functions of the ship must not be performed automatically but has to be activated by skilled personnel. A graphical interface of the control unit of the present invention may also be integrated in other control systems of the ship.

Further, even if some sensors, measuring and control devices and valves have been, or will be, described in conjunction with the present invention, it is to be understood that many other types of measuring and control devices can be used, that are all readily available to the person skilled in the art. The different devices could thus be used in conjunction with pneumatic, hydraulic, electric electronic devices and communication means and combinations of these. It is also to be understood that wired as well as wireless communication systems could be used, which could be analogue or digital, or combinations of these.

The system is intended to function as follows.

Start-up

When starting the system for e.g. ballasting the system is empty, as will be described below. The UV lamps of the reactors require some time to start and they produce a lot of heat in operation so they have to be cooled during start. In this phase they can not be cooled by the ballast water to be treated because they do not operate properly during the start-phase. It is thus necessary to have a cooling flow through the reactors during this phase. Thus the valve 22 of the main pipe is closed, and the valve 43 arranged on the inlet pipe from the cooling system of the ship is opened. The flow from the cooling system flows through the open valves 45 of the branches and into the reactors 10, where the closing valves 32 of each main pipe of the reactors are closed, in order not to create a back-flow. If one of the reactors are not to be started for some reason, its branch valve of the cooling liquid is closed.

Thus the liquid flows into the reactors and fills them. In this stage the closing valves of the return branches 48, the main outlet pipe 38 and the cleaning branches 64 are closed. The filling of the reactors is sensed by the level sensors 36 of each reactor. When the sensors indicate that the reactors are filled, a signal is sent to the control unit. The next step is then to start the lamps 76 of the reactors. During start-up the lamps are preferably started in sequence, but they may also be “soft”-started by increasing the current to the lamps in steps from zero to full. Because it takes some minutes to have them in full operation and because they produce heat, there has to be a flow through the reactors. The closing valves 48 of the return branches are then opened to allow a flow of cooling liquid. The temperatures inside the reactors are continuously monitored by the temperature sensors. The start-up period could either be set such that the reactors are ready for use after a time that is known from experience, e.g. four minutes. Instead, the voltage over the drive units of the lamps could be measured, which corresponds to the operating temperature of the lamps.

Ballasting

After a certain period of time, the lamps are operational and the reactors are ready to treat the ballast water. The control unit sends a signal or message to the control unit of the ship that the system is ready for ballasting. The ballast water pump is then activated from the control unit of the ship by personnel responsible for ballasting. In the system, the main pipe closing valve 22 is kept closed and the branch 23 valve to the filter is opened as well as the valve 26. The inlet and outlet valves of the reactors 32 and 38 respectively are also opened as well as the main outlet valve 42. The ballast water pumped in by the ballast water pump is thus directed through the filter. This may comprise a number of different filter solutions capable of separating larger components from the water, such as shrimps, mussels, seaweed and such. After the filter, the water is then fed through each main inlet pipe of the reactors. The valves of the cooling system branches, both inlet and outlet are closed. The water is then treated by the AOT technology described above for efficiently kill all organisms in the water. The water is then led via the main outlet pipe into the ballast water tanks.

Deballasting

When treating the water from the ballast tanks during deballasting, the water is pumped from the ballast tanks by the ballast water pump into the main inlet pipe. Now the closing valve 23 of the filter branch is closed and the closing valve 22 of the main inlet pipe is opened. The water during deballasting does thus not pass through the filter, but is pumped directly through the reactors. At the outlet the position valve is then positioned such that the water is pumped into the sea.

The system is preferably arranged with pumps, valves and sensor that are capable of handling ballast water that also contain air. This is the case during so called stripping of the ballast tanks, i.e. when they are emptied completely. In order to be able to remove the last volumes of ballast water, special types of air-driven pumps/ejectors utilizing venture-effects are used. Thus, the last volumes contain a lot of air and have low flows. Preferably the system includes sensors capable of measuring the amount of air in the stripped ballast water. I is also feasible to have a sensor capable of sensing the presence of oil in the ballast water, which could be the case in the last volumes of ballast water.

Many times the ballast water tanks are filled or emptied by using pumps as described above. However, ballast water tanks can be placed on many locations in a ship and sometimes the tanks are placed at levels above the outlet port of the ballast water system or below inlet ports of the ballast water. In those cases the pumps are many times not used, and instead the tanks are emptied or filled by using only gravity. The present system is capable of handling these cases as well because then the flow, although with a lower pressure is directed through the reactors and the water is treated. Because of the lower pressure the process will be slower, but the control program of the system, the sensors and different functions are programmed to handle this. When flow and pressure sensors of the system, like 28 and 29 on the incoming pipe, sense that the flow and pressure have decreased to a certain level, a signal is sent to activate the ballast water pump.

Monitoring of the reactors during ballasting/deballasting During the treatment of the ballast water, the reactors are monitored constantly. Should the temperature, sensed by the temperature sensor 34, of one reactor rise above a set temperature limit, a signal is sent to the control unit, whereby the lamps of that reactor are shut-down immediately, and an alarm signal is sent to the control panel of the ship. An alarm signal is also sent and the reactor is closed down if the temperature sensor as such breaks down. However, during start-up the valves 45, 48 for the cooling system are not closed, but a flow is allowed through the reactor. During operation however, the closing valves 32, 38 of the inlet and outlet main pipes to the reactor are closed and an alarm signal is sent to the control panel. In order to further enhance the safety aspects of the operation of the reactors, a pressure sensor could be included, giving an alarm and shutting down the reactor should the pressure drop.

Also during start-up, if the level sensor 36 in one of the reactors is activated due to that the reactor is not being filled properly, an alarm signal is sent to the control unit, which triggers a signal to shut down the lamps of that reactor. The closing valves of the inlet and outlet branch of the cooling system are closed.

Each lamp in a reactor is arranged with control means capable of indicating if a lamp is in operation or not. Should at least on lamp and/or enough lamps in a reactor fail and sufficiently UV-power not be ensured, a signal is sent to the control unit, and the reactor is immediately shut down. This means that all the lamps in the reactor are switched off and the inlet and outlet closing valves of the main pipes to that reactor are closed in order to ensure that no untreated ballast water can flow through the faulty reactor.

When a reactor has been shut-down the control unit checks that actual flow through the main pipe via the flow sensor 28 with the number of reactors in operation. If the flow is above the capacity of the reactors, an alarm is produced and sent to the control panel of the ship indicating that the flow rate exceeds the certified rate, reduce the flow.

The control unit of the ballast treatment cannot control and adjust the flow rate, because this may endanger the ship during ballasting and deballasting, this can only be done by skilled persons on the commando bridge of the ship or machine personnel. However, they must act on the alarm and take appropriate measures. Also if the ballast water pump for some reason is either switched off or brakes down, this is sensed by the flow sensor, and a signal is sent to the control unit whereby the reactors are switched off and the closing valves of the inlet and outlet main pipes of the reactors are closed.

The flows through the ballast water treatment system and all signals from sensors are logged in order to have a record of the treatment process.

Stop of Ballasting/Deballasting

When the system is to be stopped after ballasting/deballasting, certain steps are performed in order to ascertain that no untreated water can leave the ship. When ballasting has been performed and the filter has been used, the filter is first back-flushed before stop. The outlet valve 26 of the filter is then closed and the back-flush is activated by the control unit. The water used for the back-flush is, after it has passed the filter, led back to the sea. This can be done because the filter is used only during ballasting and the back-flush is performed just after ballasting, thus there is no risk in this instant of untreated water leaving the ship. Then the lamps are switched off and the closing valves of the reactor inlet and outlet pipes are closed as well as the main outlet closing valve.

The reactors are then drained of remaining water. This is done by utilizing the pipe system of the cleaning unit. Generally the inlet and outlet pipes of the cleaning system to the reactors are arranged in the bottom of the reactors. In order to drain the reactors, both the inlet and outlet valves 60, 64 of the cleaning unit are opened. The inlet valve of the main pipe of the cleaning unit is closed and a branch downstream that inlet valve is opened. That branch is in communication with the bilge tank, arrow 460, of the ship. Thus the untreated water of the reactors is led to the bilge tank and cannot thus escape the ship.

The system is also provided with a stand-by function. If a ballasting or deballasting operation has been initiated, which temporarily has to be stopped for some reason the valves of the main pipes to the reactors are closed and the cooling liquid branches are opened, allowing the cooling liquid to circulate through the reactors. In this way the lamps of the reactors do not need to be shut down during this temporary stop, which otherwise would take quite a long time if the system first had to be shut down completely and then started again as described above.

Cleaning of the Lamps

After the reactors have been drained, the lamps are cleaned, i.e. the lamps are cleaned after each ballast water cleaning process. This is done by the cleaning unit. Preferably each reactor is cleaned separately. Thus the inlet and outlet valves 32, 38 of one reactor are opened. Also the main inlet and outlet valves 60, 64 of the cleaning unit is opened and the pump 56 is started. For a period of time the reactor is thus flushed with treating liquid from the tank. The treating liquid could preferably have a low pH-value since the film of deposits on the lamps is basic. One example of a treating liquid comprises lactic whey and citric acid, which are harmless to the environment. Most of the cleaning liquid is reused in subsequent cleaning processes. However when a certain number of cleaning processes have been performed, the cleaning liquid contains so much deposit and other pollution so that it has to be replaced.

It is of course feasible to refill the reactors after the cleaning process instead of having them empty. Preferably, they are then filled with fresh water, possibly added with corrosion inhibitors, preservatives such as phosphates that have good uptake capacity, bonding ions. In this aspect, a separate fresh water tank could be connected to the reactors via a separate pipe loop.

In the above embodiment of the system, four reactors have been described. It is however to be understood that there could be from only one reactor and up to a rather large number of reactors depending on the volumes of ballast water to be treated. It is also to be understood that other treatment units utilizing UV radiation than the mentioned AOT system can be used with the present invention. In that respect UV generating means that cover the whole UV spectra 100-400 nm may be utilized.

As mentioned above, The AOT purifier is arranged with a number of lamps. A drive unit is connected to each lamp for operating it, which drive units are placed in a cabinet 120. The operation of the UV lamps requires that each drive unit provides enough power to the lamps. This in turn means that the drive units emit quite a lot of heat inside the cabinet, which heat has to be taken care of in order not to overheat the components inside the cabinet. Since the cabinets may be placed in environments requiring that they fulfill the requirements regarding safety against explosions, so called EX-class equipment, the cabinets are arranged substantially gas-tight.

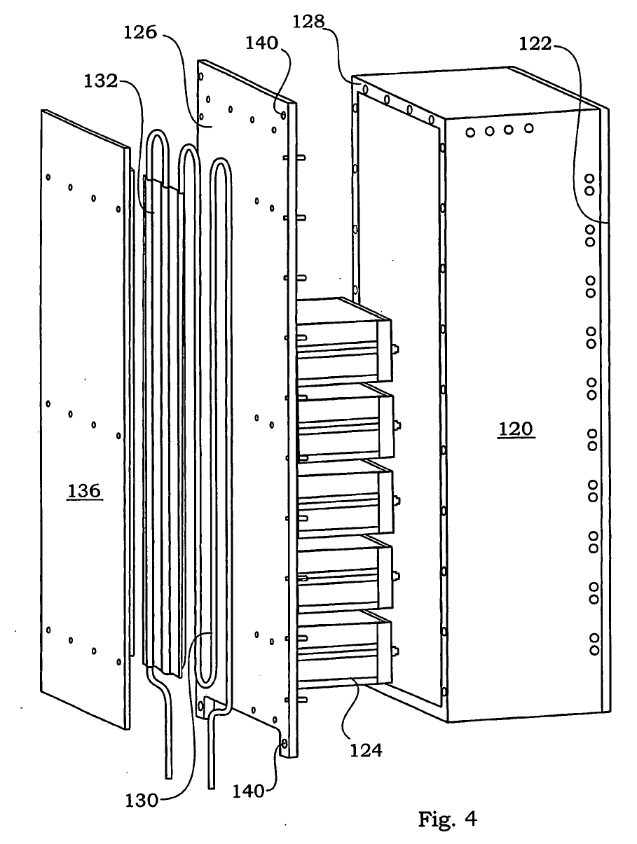

FIG. 4 shows one embodiment of a cooling device according to one aspect of the present invention. It is arranged to a cabinet 120 made of a material suitable for the environment and climate it is arranged to be placed in. It could for example be made of metal sheet, single or double walled, having a coating to withstand for example moist, salt water and the like. It could also be made of stainless steel in demanding environment. If the cabinet is double walled it may have insulation, as will be discussed below. The cabinet is arranged to meet up to the standards for an explosive safe environment, a so called EX-class, as is well defined within the standard classification. The cabinet is arranged with a front door 122, having locking means (not shown) for closing and keeping the door locked. A seal (not shown) is arranged between the door and the cabinet for sealing the interior of the cabinet from the surrounding. Gas-tight seals are also arranged around all through-going components such as cables.

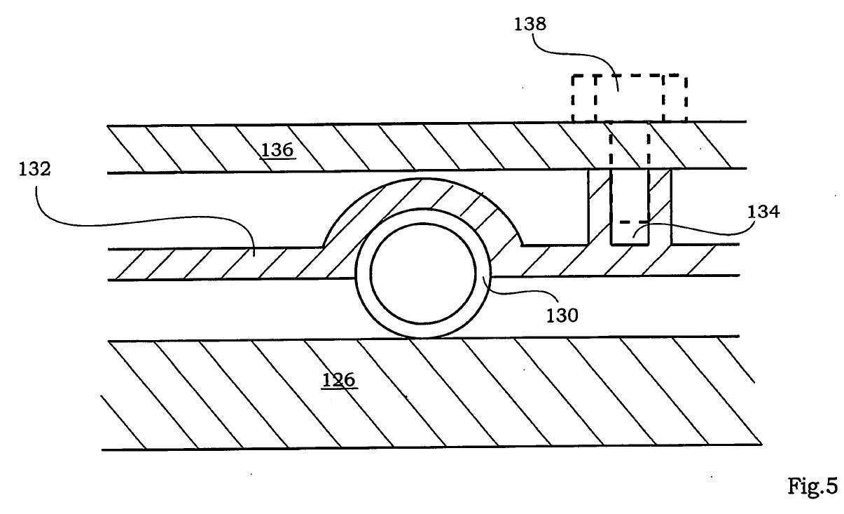

Inside the cabinet the drive units 124 are arranged for the purifying reactor lamps. The drive units comprise inter alia drive transformers for the lamps comprising units which are capable of delivering the power to operate the lamps. As a standard the cabinet contains ten drive units for the ten lamps that are arranged in one reactor. Each drive unit is arranged with a number of fans, for example three, that are capable of circulating air around the drive means for cooling them. The drive units are attached directly on a base plate or panel 126, forming a part of the cooling device and which plate constitutes the back panel of the cabinet. The back panel is preferably made of a thick metal plate of for example aluminium, preferably at least 15 mm thick, which is a good heat transfer material. The back panel is fixedly attached to the cabinet with a plurality of bolts that fit into mating threaded holes in the cabinet. Further a seal 128 is arranged between the back panel and the cabinet, for ensuring the EX-classification. There are a number of materials suitable for sealing, such as rubber, a number of plastics and the like. On the outer surface of the back panel a cooling circuit 130 is arranged. It comprises in the embodiment shown a piping of a non-corrosive material bent in a number of turns that cover a major part of the back panel. The piping is held in position by a fixating plate 132 made of for example extruded aluminium that is formed to contain and fixate the piping. The fixating plate is bolted to the back plate in an appropriate manner. The fixating plate is further arranged with longitudinal grooves 134. Outside the piping and the fixating plate an insulating plate 136 is arranged, covering the back plate. The insulation plate is attached to the cooling unit in that self threading bolts 138, FIG. 5, are screwed in holes mating the longitudinal grooves 134 of the fixating plate, thus threaded into the grooves.

In this manner the cooling piping is in contact with the back panel on to which the heat generating equipment inside the cabinet are attached. Outside the cooling piping the insulation plate ensures that the cold from the cooling media is not spread to the environment. Due to the thickness of the back panel, it functions well as a heat transfer means and also to give good support to the components attached to the panel. Further, threaded attachment holes may be made in the back panel without having to be through-going. The back panel is further arranged with fastening means, such as through-going holes 140, for attaching the cabinet to a wall or other planar surfaces.

The cooling piping is preferably connected to the low temperature (LT) water circuit of the ship, which water circuit is a closed circuit having a controlled temperature and is also used for cooling other equipment of the ship. If no LT water is available, sea water could be used. One advantage with sea water is that it is relatively stable regarding temperature variations. In order to ensure the function of the piping for different types of cooling media and to avoid corrosion, it is preferably made of stainless steel. The circulation of the water through the cooling piping could be done continuously, i.e. the circulation does not have to be switched on and off depending on the operation of the equipment inside the cabinet.

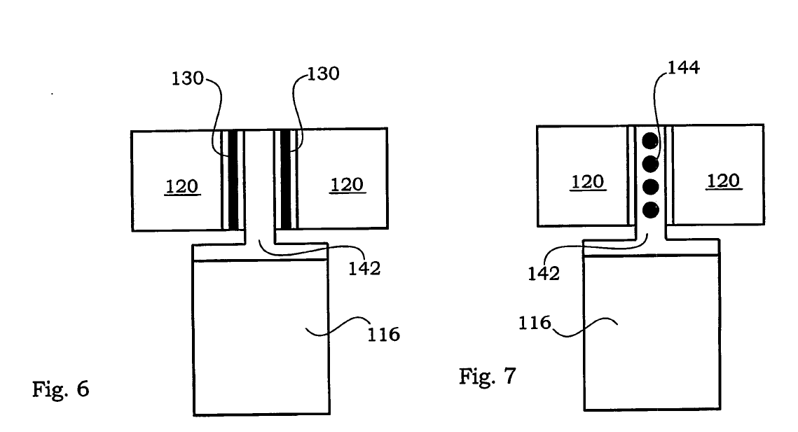

When more than one reactor is used, or more than one cabinet is used for one reactor, the cabinets may be placed on a common consol 142, which in turn is attached to the reactor 10, in order to have a compact space-saving solution, as shown in FIG. 6. In this case each cabinet is arranged with their own cooling device as described above. It is also feasible to have a common cooling device 144 according to the present invention as shown in FIG. 7. In this case the consol could constitute and/or comprise the back panels of the cabinets and comprise the cooling piping. In this case the dimensions of the cooling piping probably need to be larger than for a single cabinet.

It is also conceivable to have a closed loop cooling piping attached to the back panel and communicating with a small heat exchanger if for some reason it is not favourable or appropriate to use external cooling media in the cooling piping. As mentioned above, the circulation of cooling media could be continuous regardless of if the equipment is on or off. However a temperature sensor could be placed inside the cabinet, or the temperature sensors that are arranged to each drive unit, could be used for measuring the overall temperature inside the cabinet. If the temperature should rise above a preset value, this could trigger an increase in the circulation of cooling media in the cooling device.

Even though the cooling device has bee described as being arranged with a back panel, the person skilled in the art realizes that the cooling device according to the present invention may be part of the any of the walls of the cabinet. For example if the cooling requirements are high, cooling devices may be arranged on the back as well as on the side of the cabinet. It is further conceivable to have insulation in the walls of the cabinet that are not arranged with a cooling device if the surrounding temperature is higher than inside the cabinet.

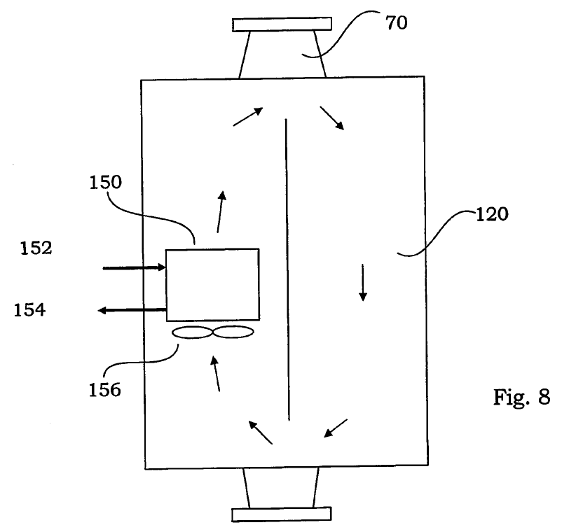

FIG. 8 shows another embodiment of a cooling device comprised in the present invention. The cabinet 120 is mounted on the reactor 10, or placed in close vicinity thereof. An air/liquid heat exchanger 150 is placed inside the cabinet 120. The heat exchanger is connected to inlet 152 and outlet 154 of a cooling water circuit in the same manner as described above. Further a fan is placed in the vicinity of the heat exchanger and directed to blow air through it. The cooling device works such that cooling liquid flows through the heat exchanger. The fan distributes the air cooled by the heat exchanger throughout the cabinet, ensuring proper cooling of the components. In this aspect, the cabinet could be arranged with baffles and guide means that are capable of directing the air towards specific areas and components.

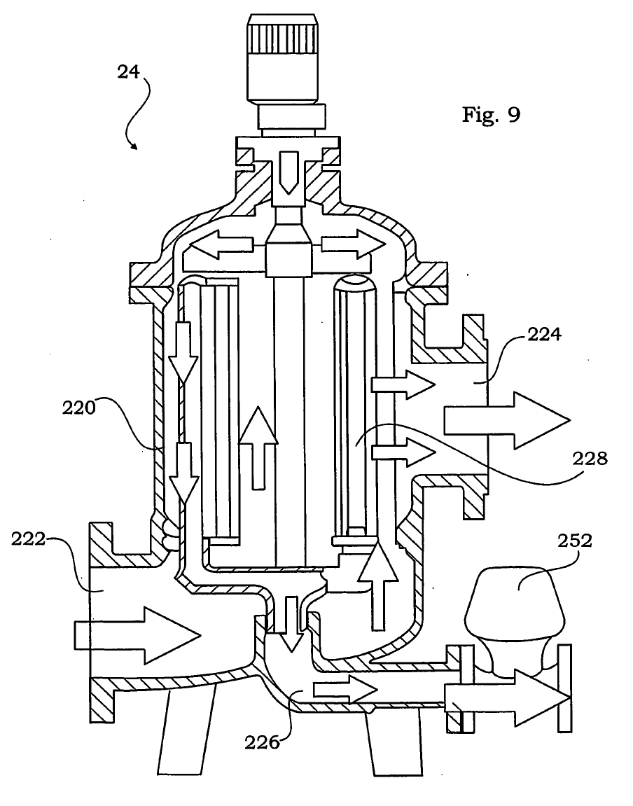

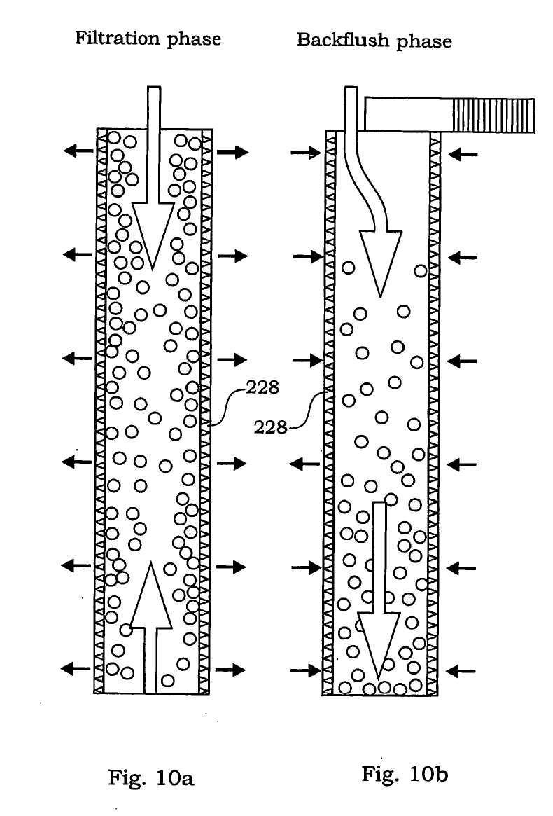

The filter used in the above system may be of a type shown in FIG. 9. It comprises a housing 220 having a main inlet 222 and a main outlet 224 for the water to be filtered. Inside the housing a number of generally cylindrical filter elements 226 are arranged such that the filtered water passes through the filter elements, FIG. 10a. The design of the filter elements could be a wedge wire filter type capable of filtering out particles larger than 50 micron, which is a common type of filter design. It is however to be understood that other types of filter elements may be utilized that are capable of filtering out particles above a certain size.

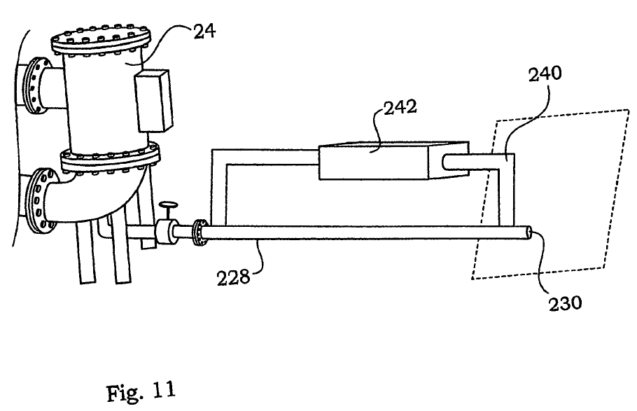

After the ballasting process is completed the filter is to be cleaned from the filtered off particles and organisms. For doing this the filter is back-flushed, as seen in FIG. 10b. The flow through the filter is thus reversed. Then the inlet and outlet valves to the filter are arranged such that the inlet side is closed and incoming water from the sea is directed through the outlet of the filter. Further, the filter cleaning liquid is fed to a separate back flow outlet 226 of the filter, which then is connected to a piping 228 having a discharge outlet 29, FIG. 11, into the sea.

One problem with this back-flush operation is that there will be some liquid remaining in the back flow outlet piping 228, which liquid is contaminated with organisms from the ballasting place and in particular organisms that was filtered out and then removed from the filter during the back-flush. At the subsequent back flow cleaning after a subsequent ballasting operation at another location, the contaminated water in the back flow piping from the previous location will be discharged at the new location.

In order to eliminate this problem, the present invention presents a solution of handling this water and to avoid any contaminations.

According to one aspect of the invention the filter is back-flushed more than one time before the system is closed down, in order to reduce the number of organisms in the back-flush piping. For each back-flushing sequence, the contamination will be less which will reduce the number of organisms in the piping.

According to another aspect of the invention fresh water is utilized, either for flushing only the back-flush piping, or also the filter, when the ballast water operation is completed in order to push out the contaminated water back to its original place and to have only fresh water in the back-flush piping.

The back-flush sequence can for example be made twice in order to clean the back-flush pipe thoroughly. For the flushing also hot tap water can be used. With hot tap water the filter can be cleaned from contaminants, but also disinfected by the hot water as well as the back-flush piping. When tap water is used from the ship cold or hot, it is possible to use the existing pressure from the tap water system, whereby no further pressure means like pumps are necessary. Since the filter only needs to be filled within some hours for this operation, when the ship still is at the origin, it will not have any major influence on the onboard capacity of the fresh water system. Instead of the tap water, flushing could be performed with engine cooling water for a continuous cleaning of the filter and back-flush piping, which also is possible whilst the ship is in open ocean as defined by IMO (the International Maritime Organization). It is of course possible to use the warm water from the cleaning process to fill the reactors when not in use, as described above.

According to a further aspect of the invention, the contaminated water remaining in the back-flush piping can be treated with some sort of cleaning process. For example a circuit 240, FIG. 11, containing a treatment unit 242 and a circulation pump (not shown) may be arranged to the back-flush piping, preferably connecting to both ends of the back-flush piping 228. The treatment unit could for example include an AOT unit functioning in the same manner as the treatment units of the ballast water treatment system, as described above.

It is of course also feasible to use vapour or steam as the treatment fluid for the filter and the back-flush piping. Suitable means for creating vapour and preferably also heating the vapour are then arranged in connection to the system. The heated vapour would then have the same disinfecting function as hot water. It is further possible to have combinations of water and vapour with the present system. Further gas could also be used, for example ozone, for treating the filter and back-flush piping, either alone or in combination with other fluids.

Advantageously, when the filter has been used and is not to be used again in a while, it could be filled with hot water to prevent fouling of the interior of the filter. As mentioned in connection with the reactors above, the water could be added with inhibitors and preservatives.

The control system according to the present invention could further comprise control means for automatically performing the back-flush piping cleaning. The filter could for example include valve control means as well as sensors connected to the control system. The back-flush operation may then for example be initiated automatically if the filter is arranged with pressure sensing means capable of sensing the pressure drop over the filter. If the pressure drop is above a certain limit the system will initiate a self-cleaning cycle. Of course the back-flush operation may be initiated manually. The system could further be provided with a counter that keeps track on the number of times that the filter has been back-flushed.

As an example a filter operation will be described below. At the end of the ballasting operation the main, remotely controlled, inlet and outlet valves of the ballasting system are closed by the control system. Then a remotely controlled valve at the bottom of the filter, connected to the back-flush piping, is opened and the filter is drained for a certain time period. The valve at the bottom of the filter is then closed and the filter is filled with hot fresh water from a fresh water inlet pipe. When a certain pressure has been reached inside the filter housing, a back-flush/reject sequence starts one complete reject cycle to flush the back-flush outlet piping and out through the discharge opening and overboard. After this the hot fresh water inlet is closed and for best preservation of the filter during stand still the filter housing, the valve at the bottom of the filter and the back-flush piping are left filled up with hot fresh water.

It is also to be understood that the example described above end shown in the drawings is to be regarded as a non-limiting example of the invention and that it may be modified within the scope of protection of the patent claims.

What is claimed is:

1-45. (canceled)

46. A method for operating a system for treating contaminated ballast water, comprising water inlets and outlets, piping connected to said inlets and outlets, at least one treatment unit comprising UV-radiating means connected to said piping, which treatment unit is openable to treat ballast water flowing through said unit, filter means for said ballast water, valve means for controlling the flow through said piping, for controlling the flow through said treatment unit and for controlling the flow through said filter means, wherein a control unit is arranged and capable of managing and controlling all the different process sequences during start-up, ballasting, deballasting and cleaning as well as failure functions.

47. A method for operating a system according to claim 46, wherein the control unit, via the piping and valve means, directs water during ballasting through the filter before entering the treatment unit.

48. A method for operating a system according to claim 46, wherein the method also comprises providing the treatment unit with non-contaminated water during start-up of said treatment unit, and once said treatment unit is in operation, supply contaminated ballast water.

49. A method for operating a system according to claim 48, wherein the system also comprises level sensors arranged in said treatment unit and connected to said control means, and wherever said method includes using said sensors to sense the water level and control means being operable to cause an alarm if said level is detected to be below a certain threshold, leading to a shut-down of said treatment unit.

50. A method for operating a system according to claim 46, wherein the system also comprises temperature sensors arranged in said treatment unit, said method including said control means causing the temperature sensors to detect the temperature, said control means further being capable of issuing an alarm if said temperature is above a certain threshold, leading to shutting down of said at least one treatment unit.

51. A method for operating a system according to claim 46, wherein the UV radiating means, said control means being capable of sensing the function of said UV radiation means and capable of issuing an alarm if said UV radiation means is mal-functioning, leading to shutting down of said at least one treatment unit.

52. A method for operating a system according to claim 51, wherein said issuing an alarm further comprises request adjustment of the flow of ballast water through the system due to shut-down of the at least one treatment unit.

53. A method for operating a system according to claim 52, wherein the flow of ballast water through the system is logged together with the actual treating capacity of the said at least one treatment unit.

54. A method for operating a system according to claim 46, wherein the method also comprises back-flushing said filter at the end of a ballasting process.

55. A method for operating a system according to claim 46, wherein the method also comprises emptying said at least one treatment unit after completing a treatment process, whereby the control unit, via the piping and valve means, is operable to direct the emptied water into a bilge tank of a ship.

56. A method for operating a system according to claim 55, wherein the system further comprises a cleaning unit comprising cleaning liquid, and whereby the control unit, via the piping and valve means is operable to direct cleaning liquid into said at least one treatment unit.

57. A method for operating a system according to claim 46, wherein the control unit further comprises communication means and said method includes causing said communication means to communicate one or more of status, actions and alarms to an overall control system of a ship.

58. A method for operating a system according to claim 57, further comprising directing water during ballasting through the filter means before entering the treatment unit.

59. A method for operating a system according to claim 46, wherein the filter means is connected to back-flush piping between said method further includes filter and a discharge outlet, and said filtering objects in a contaminated fluid via said filter means.

60. A method for operating a system according to claim 46, wherein the method also comprises:
creating a back-flush flow through said filter and said back-flush piping, and
treating at least said back-flush piping with fluids in order to remove contaminants from the back-flush piping that have been removed from the filter during said back-flush flow.

61. A method for operating a system according to claim 46, wherein at least one of said filter and said back-flush piping is treated several times with a flow of fluids in order to remove contaminants from the back-flush piping.

62. A method for operating a system according to claim 61, wherein the method also comprises that each time the back-flush flow is back flushing the pipes or the filter fresh fluids are added to at least one of the back flush piping and the filter.

63. A method for operating a system according to claim 61, wherein said fluids include one or more fluids selected from the group containing fresh water, vapour and gas, or combinations thereof.

64. A method for operating a system according to claim 63 wherein said gas is ozone.

65. A method for operating a system according to claim 63, wherein said fresh water is supplied from at least one of a tap water system of the ship and an engine cooling system of the ship.

66. A method for operating a system according to claim 46, wherein the method also comprises cleaning of a filter arranged in a ballast water treatment pipe system, which pipe system comprises back-flush piping between said filter and a discharge outlet, which filter has been used for filtering objects in a contaminated liquid, said system further including means for creating a back-flush flow through said filter and said back-flush piping, and means for treating at least said back-flush piping with fluids in order to remove contaminants from the back-flush piping that have been removed from the filter during said back-flush flow.

67. A method for operating a system according to claim 64 wherein said fresh water is heated prior to treatment.

68. A method for operating a system according to claim 46, wherein the system also comprises control means and sensors for performing the method automatically.

69. A method for operating a system according to claim 68, wherein said control means and sensors comprise pressure sensing means operable to sense a pressure drop over said filter, and, if the pressure drop is above a certain threshold, initiate the method.

70. A method for operating a system according to claim 46, wherein the system also comprises means for providing fluids selected from the group containing fresh water, vapour and gas.

71. A method for operating a system according to claim 70, wherein said fresh water means is a tap water system of the ship or said fresh water means is an engine cooling system of the ship or the system further comprises heating means for heating said fluids.

72. A method for operating a system according to claim 71, wherein the method also comprises cleaning of a filter arranged in a ballast water treatment pipe system, which pipe system comprises back-flush piping between said filter and a discharge outlet, which filter has been used for filtering objects in a contaminated liquid, said system further including means for creating a back-flush flow through said filter and said back-flush piping, and means for treating at least said back-flush piping with fluids in order to remove contaminants from the back-flush piping that have been removed from the filter during said back-flush flow.

73. A method for operating a system according to claim 72 wherein said fresh water is heated prior to treatment.

74. A method for operating a system according to claim 46, wherein the control unit is controlling all the different process sequences during start-up, ballasting, deballasting and cleaning as well as all failure functions, whereby contaminated water is prevented from leaving the system.

75. A system for treating contaminated ballast water, comprising water inlets and outlets, piping connected to said inlets and outlets, at least one treatment unit comprising UV-radiation means said at least one treatment unit being connected to said piping, the system further comprising filter means, a control unit, valve means connected to said piping, and said control unit being arranged to control said valve means.

76. A system for treating contaminated ballast water according to claim 75, wherein the control unit is connected to level sensors and temperature sensors arranged within said at least one treatment unit.

77. A system for treating contaminated ballast water according to claim 75, wherein the system also comprises a cleaning unit comprising cleaning liquid connected via piping and valve means to the at least one treatment unit.

78. A system for treating contaminated ballast water according to claim 44, wherein the control unit comprises computer code means and/or software code portions for a processor arranged in said control unit.

79. A system for treating contaminated ballast water according to claim 75, wherein the system also comprises a cabinet arranged for containing heat generating components such as drive units for the UV-radiating means, wherein said cabinet is substantially gas-tight, wherein the cabinet further comprises a cooling device, which device comprises a heat conducting panel attachable to said cabinet, and when attached is arranged adjacent said heat generating components, piping arranged to said panel and connectable to cooling media, attachment means for attaching said piping in contact with said panel, and further comprising insulation arranged outside said piping.

80. A system for treating contaminated ballast water according to claim 79, wherein said panel constitutes a wall part and is attached sealingly to said cabinet.

81. A system for treating contaminated ballast water according to claim 79, wherein said heat generating components are attached to said panel and wherein the surface of the panel facing the interior of the cabinet is arranged with cooling fins.

82. A system for treating contaminated ballast water according to claim 79, wherein the fastening means comprises elongated profiles having channels for accommodating said piping.

83. A system for treating contaminated ballast water according to claim 75, wherein the system also comprises a cabinet arranged for containing heat generating components, wherein said cabinet is substantially gas-tight, wherein the cabinet further comprises a cooling device, which device comprises a heat exchanger connectable to cooling media, and a fan arranged adjacent said heat exchanger inside said cabinet.

84. A system for treating contaminated ballast water according to claim 83, wherein the cooling device of the cabinet is connected via piping to a low temperature water circuit of a ship.
